(19) United States
(12) Patent Application Publication
(10) Pub. No.: US 2012/0290479 A1
(43) Pub. Date: Nov. 15, 2012

(54) Integration of a Payment Network with Systems of Multiple Participating Banks

(75) Inventors: Amy Beth Hoke, Gilford, NH (US); Christopher Curtis Martin, Portsmouth, NH (US); Robert Arntz Eberle, North Hampton, NH (US); Elizabeth Kaye Ashey, Cumberland, ME (US); Thomas Dawson Gaillard, Exeter, NH (US)

(73) Assignee: Bottomline Technologies (DE) Inc., Portsmouth, NH (US)

(21) Appl. No.: 13/400,099

(22) Filed: Feb. 19, 2012

Related U.S. Application Data
(63) Continuation-in-part of application No. 13/068,558, filed on May 13, 2011.
Application No. 13/068,558 is a continuation-in-part of application No. 13/136,728, filed on Aug. 9, 2011.
Application No. 13/136,728 is a continuation-in-part of application No. 13/200,581, filed on Sep. 26, 2011.
Application No. 13/200,581 is a continuation-in-part of application No. 13/374,071, filed on Dec. 9, 2011.
Application No. 13/374,071 is a continuation-in-part of application No. 13/374,487, filed on Dec. 30, 2011.

(51) Int. Cl. G06Q 20/10

(52) U.S. Cl. 705/44; 705/39

(57) ABSTRACT

A payment system making payments from each payer of a community of payers to each vendor of a community of vendors. The payers are grouped into mutually exclusive sub groups, each being associated with one of a group of participating banks. Upon receipt of a payment instruction file from a bank, including instructions for executing payments from payers in the subgroup associated with the bank to various vendors, the system: i) obtains authorization of a funding amount for each payer; ii) provides a transaction to transfer the funding amount from the payer's account to a pooling account held by the originating bank; and iii) after receipt of the funding amount in the pooling account, provides an EFT file for payment of the vendors. Multiple banks are supported. The vendors are not associated with any particular bank.

### TECHNICAL FIELD

The present invention relates to electronic payment and remittance systems and more particularly, to an electronic payment and remittance system which assesses a variable transaction fee to each vendor and provides a variable rebate to each payer.

### BACKGROUND OF THE INVENTION

Electronic payments are becoming more common place for settling both consumer and business to business transactions. The most common electronic payment mechanism in the consumer world is a payment card such as a credit card, charge card, or debit card. Generally, payment cards are issued by an operator of a card payment system such as American Express or Diners Club (sometimes called a closed loop system), or by a bank or financial institution under licensing from a bank card brand provider such as Visa or Mastercard (formerly bank card associations).

In a card payment system, the financial institution issuing the card handles authorizations and all aspects of the transaction and settles payment with the merchant/vendor and the consumer/cardholder. More specifically, when a consumer pays for a purchase using a credit card issued as part of a card payment system, the merchant/vendor's point of sale terminal is used to obtain, from the issuer, an authorization for the payment amount. The authorization represents a guarantee that the issuer will pay the authorized amount. Once authorization is obtained the merchant/vendor can provide the goods or services without concern as to whether the consumer will pay for the goods or services because consumer credit risk is on the issuer that provided the authorization (guarantee of payment), not the merchant/vendor that obtained the authorization (guarantee of payment). To settle the transaction, the issuer pays the merchant/vendor the authorized amount less a transaction fee. The transaction fee is established by contract between the merchant/vendor and the card payment system operator/issuer at the time the merchant/vendor opens its merchant account with the close loop system operator/issuer.

When a bank or financial institution issues a payment card under licensing from a bank card brand provider such as Visa or Mastercard, the bank is referred to as the Issuing Bank. To accept payment by payment card issued under license from a bank card brand provider, a merchant/vendor opens a merchant account with a bank of financial institution that is also licensed by the bank card brand provider. The bank at which the merchant/vendor has its merchant account is called the Acquiring Bank. The Issuing Bank and the Acquiring Bank may be different banks.

When a consumer pays for a purchase using a payment card licensed under a bank card brand provider, the vendor's point of sale terminal is used to access the brand provider's settlement network and obtain an authorization for the payment amount. The authorization represents a guarantee that the Issuing Bank will fund the authorized amount. Once authorization is obtained, the transaction is processed. More specifically, the Acquiring Bank funds the vendor's Merchant Account with the amount of the transaction less a transaction fee that is established by contract between the Acquiring Bank and the merchant/vendor. The Acquiring Bank obtains payment from the Issuing Bank through the brand provider's settlement network and pays a fee, called an interchange fee, to the brand provider. The brand provider keeps a portion of the interchange fee and credits a portion of the interchange fee back to the Issuing Bank.

The issuer in the card payment model and the Issuing Bank in the bank brand provider model may use a portion of the transaction fee (or the Issuing Bank's portion of the interchange fee) to fund a reward program that provides some financial benefit to the cardholder or, in the case of a commercial card program, rewards back to the company. Examples of reward programs include airline mileage reward programs and cash back rebate programs (for example 1% cash back). The terms and conditions of the reward program, and the financial benefit provided to the cardholder under the reward program, is controlled by the issuer/Issuing Bank.

Further, the issuer in the card payment model and the Issuing Bank in the bank brand provider model may charge the cardholder for use of the card. Such a charge is typically in the form of an annual fee. The amount of any charge to the cardholder is determined by the issuer/Issuing Bank.

It should be appreciated that the cardholder (i.e. the payer) making payment to the merchant/vendor does not determine the transaction fee paid by the vendor. The transaction fee paid by the vendor is determined by the issuer in the card payment model and the Acquiring Bank in the brand provider model.

Recently, card issuers, in particular the bank card brand providers and their participating banks, have been marketing card payments for business to business transactions. In general, an Issuing Bank issues a purchase card to a business and the business uses the card to pay vendors. Vendors must have a Merchant Account with an Acquiring bank and pay the applicable fees as determined by the Acquiring Bank. The Acquiring bank pays an interchange fee on the transaction, at least part of which is paid to the Issuing Bank. Currently purchasing card payments represent less than 4% of the business to business payments in the United States. It is speculated that purchasing card payments are not being adopted for business to business transactions as rapidly as adoption for consumer transactions for at least two reasons. First, most business to business payments are payments in the ordinary course of an ongoing relationship between the vendor and the payer and the vendor sees little credit risk in being paid. As such, the vendor sees little advantage of receiving a guarantee of payment at authorization, and while many vendors may be willing to pay a small transaction fee for the convenience of immediate payments, the guarantee of immediate payment is not enough to justify payment of the high fixed transaction fee charged by the Acquiring Bank. Second, purchase card payments are difficult for both the payer and the vendor to reconcile in their respective accounts payable and accounts receivable accounting systems without at least duplicating manual entry of at least some payment/remittance information in multiple systems.

Even though there has been little adoption of purchase cards and card payments for business to business transactions, business to business payers still seek electronic payment solutions to lower costs associated with traditional check payments, and possible generate revenue from, their accounts payable.

In view of the foregoing, what is needed is an improved an electronic payment and remittance system when enables a payer to determine, on a vendor specific basis, the fee, if any, that the vendor will pay for receipt of payments and the rebate, if any, the payer will receive based on payments to each vendor.

### SUMMARY OF THE INVENTION

A first aspect of the present invention comprises a system for making payments from each payer of a community of payers to each vendor of a community of vendors. The community of payers comprises multiple distinct sub groups of payers, each sub group of payers being uniquely associated with a distinct bank of a group of participating banks.

The payment system comprises a payer database encoded to computer readable medium. The payer database comprises a unique payer record for each payer of the community of payers. Each payer record comprises: i) identification of a distinct one of the payers; and ii) a unique system ID assigned to the payer.

The payment system further includes a vendor database encoded to computer readable medium. The vendor database comprises a unique vendor record for each vendor of the community of vendors. Each vendor record comprises: i) identification of a distinct one of the vendors of the community of vendors; ii) a unique system ID assigned to the vendor; and iii) a vendor remittance account identifier. The vendor remittance account identifier comprises a routing number and account number of a bank account to which payments to the vendor are transferred, which may be at a non-participating bank.

The system may further comprise a participating bank database encoded to computer readable medium. The participating bank database comprises a unique bank record for each participating bank of the group of participating banks. Each bank record comprises: i) identification of a distinct one of the banks of the group of participating banks; and ii) a pooling account identifier. The pooling account identifier may comprise a routing number and account number of an account of the bank from which all payments initiated by the sub-group of payers associated with the bank are paid.

The system further comprises a group of unique payment instruction files, each coded to computer readable medium. Each payment instruction file may be generated by a distinct originating bank or a distinct one of the payers. The originating bank may be a bank within the group of participating banks.

Each payment instruction file from an originating bank comprises: i) identification of the originating bank; and ii) a group of unique payment records. Each unique payment record comprises: i) the system ID of a disbursing payer, the disbursing payer being a payer within the sub group of payers associated with the originating bank; ii) the system ID of a selected vendor, the selected vendor being a vendor within the community of vendors to which the disbursing payer is issuing a payment; and iii) identification of the amount of the payment.

Each payment instruction file from a disbursing payer comprises identification of the disbursing payer and a group of unique payment records. Each payment record comprises: i) the system ID of a selected vendor, the selected vendor being a vendor within the community of vendors to which the disbursing payer is issuing a payment; and ii) identification of the amount of the payment.

The system may further comprise a payment application comprising instructions coded to computer readable medium and executed by a processor. The instructions comprise, in response to receipt of a payment instruction file, generating an electronic funds transfer file with a group of fund transfer records by, for each payment record of the payment instruction file: i) assigning a unique payment ID to the payment record of the payment instruction file and populating the payment ID to a unique one of the fund transfer records; ii) populating the amount of the payment to the fund transfer record; iii) looking up in the participating bank database, the pooling account identifier of the originating bank and populating the pooling account identifier of the originating bank to a field of the fund transfer record identifying an account from which the payment is debited; and iv) looking up, in the vendor database, the vendor account identifier for the selected vendor and populating such vendor account identifier to a field of the fund transfer record identifying an account to which the payment is credited.

The instructions may further comprise, after the electronic funds transfer file is generated: i) looking up the originating bank; and ii) transferring the electronic fund transfer file to the originating bank for execution.

In on sub aspect, each payment record of each payment instruction file further comprises remittance information. The remittance information may be text describing the purposes of the payment. In this sub aspect, the system further comprises a remittance database encoded to computer readable medium. The remittance database comprises a group of remittance records. Each remittance record comprises, for a unique payment: i) the payment ID; ii) the system ID of the disbursing payer; iii) the system ID of the selected vendor; iv) the payment amount; and v) the remittance information.

In this sub aspect, the instructions of the payment application further include, for each fund transfer record generated, populating to a unique record of the remittance database: i) the payment ID; ii) the system ID of the disbursing payer; iii) the system ID of the selected vendor; iv) the payment amount; and v) the remittance information.

In this sub aspect, the system further comprises a remittance instructions encoded to computer readable medium and executed by a processor. The remittance instructions operate in response to a connecting vendor establishing a secure session with the system and comprise: i) generating a remittance object by looking up those remittance records of the remittance database which includes the system ID of the connecting vendor and populating those remittance records to the remittance object; and ii) rendering the remittance document on a remote system of the connecting vendor.

In another sub aspect, each payer record of the payer database further includes a payer transaction account identifier. The payer transaction account identifier may comprise a routing number and account number of a bank account from which funding is obtained for payments issued by the payer, which may be at a non-participating bank.

In this sub aspect, the instructions of the payment application further include: i) in response to receipt of each payment instruction file, calculating, for each disbursing payer (if more than one is represented), a funding total. The funding total for a disbursing payer may be the sum of the amounts of all payments represented by payments records in the payment instruction file which are being made by the disbursing payer. The instructions further include generating, for each disbursing payer, a funding transaction by: a) looking up, in the payer database, the payer transaction account identifier for the disbursing payer and populating such payer transaction account identifier to a field of the funding transaction which identifies an account from which to debit the funding total; b) looking up, in the participating bank database, the pooling account identifier of the originating bank; and c) populating the pooling account identifier to a field of the funding transaction with identifies an account to which the funding total is credited.

This sub aspect may further comprise obtaining approval of the disbursing payer prior to initiation of the funding transaction. In this sub aspect, the system further comprises funding approval instructions coded to computer readable medium and executed by a processor.

The funding approval instruction comprise: i) in response to each disbursing payer establishing a secure session with the system, generating a funding approval object by looking up the funding total calculated for the disbursing payer; ii) rendering the funding approval object with the funding total on a remote system of the disbursing payer; and iii) obtaining disbursing payer approval of the funding total from the remote system on which the funding approval object is rendered. The instructions of the payment application only provide the funding transaction to the originating bank after disburser payer approval of the funding total is obtained.

In yet another sub aspect, the payment amount in each record of the payment instruction file may be a gross payment amount and the payment amount in each record of the electronic funds transfer file may be a net payment amount. The net payment amount may be the gross payment amount reduced by a vendor transaction fee.

In this sub aspect, the instructions of the payment application further include calculating an aggregate transaction fee. The aggregate transaction fee may be the sum of each vendor transaction fee for each record of the electronic funds transfer file.

An operate fee transaction is then generated by: i) populating the pooling account identifier to a field of the operator fee transaction which identifies an account from which an operator fee is to be debited, ii) populating an operator account identifier to a field of the operator fee transaction which identifies an account held by the operator of the system and to which the operator fee is to be credited; and iii) populating the amount of the operator fee to a payment amount field of the operator fee transaction, the amount of the operator fee being a portion of the aggregate transaction fee. The operator fee transaction is then provided to the originating bank for processing.

In yet another sub aspect, the operator fee is less than one hundred percent of the aggregate transaction fee and the instructions of the payment application further include calculating an originating bank revenue share amount. The originating bank revenue share amount may be the aggregate transaction fee less the operator fee.

In this sub aspect, the instructions of the payment processing application further generate a revenue share transaction by: i) populating the pooling account identifier to a field of the revenue share transaction which identifies an account from which an revenue share amount is to be debited; ii) populating an account identifier of an account owned by the originating bank to a field of the revenue share transaction which identifies an account to which the revenue share amount is to be credited; and iii) populating the revenue share amount to a payment amount field of the revenue share transaction. The revenue share transaction is provided to the originating bank for processing. The portion may be the aggregate transaction fee less the operator fee.

In yet another sub aspect, each vendor record of the vendor database further includes a unique group of payer rate records. Each payer rate record includes, for a payer of the community of payers that makes payment to the vendor, the system ID assigned of the payer and a transaction fee rate applied to payments from the payer to the vendor.

The transaction fee rate of at least one payer rate record associated with a vendor record may be different than the transaction fee rate of at least a second payer rate record associated with the same vendor record.

The transaction fee rate for at least one payer rate record associated with a first vendor record that includes a system ID assigned to a first payer is different than the transact fee rate of at least one payer rate record associated with a different vendor record that also includes a payer rate record with the same system ID assigned to the first payer.

In this sub aspect, the instructions of the payment application further include, for each record of the electronic funds transfer file: i) looking up, in the vendor database, in the vendor record with the system ID of the selected vendor, the transaction fee rate in the payer rate record with the system ID of the disbursing payer; and ii) calculating the vendor transaction fee, the vendor transaction fee being the product of the transaction fee rate multiplied by the gross payment amount.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing architecture of a system for making payments from each payer of a community of payers to each vendor of a community of vendors, all in accordance with an exemplary embodiment of the present invention;

FIG. 2 is a block diagram representing a payer in accordance with an exemplary embodiment of the present invention;

FIG. 3 is a block diagram representing a vendor in accordance with an exemplary embodiment of the present invention;

FIG. 4 is a table diagram representing a matching of sensitivity scores to industry codes in accordance with an exemplary embodiment of the present invention;

FIG. 5a is a table diagram representing data elements stored in, and relationships between data elements stored in, a vendor registry in accordance with an exemplary embodiment of the present invention;

FIG. 5b is a table diagram representing data elements stored in, and relationships between data elements stored in, a payer registry in accordance with an exemplary embodiment of the present invention;

FIG. 5c is a table diagram representing data elements stored in, and relationships between data elements stored in, a participating bank registry in accordance with an exemplary embodiment of the present invention;

FIG. 5d is a table diagram representing data elements stored in, and relationships between data elements stored in, a remittance database in accordance with an exemplary embodiment of the present invention;

FIG. 6a is a flow chart representing a first aspect of operation of a fee tier assignment application in accordance with the present invention;

FIG. 6b is a flow chart representing a second aspect of operation of a fee tier assignment application in accordance with the present invention;

FIG. 7 is a graphic depicting an exemplary user interface for fee tier assignment in accordance with and exemplary embodiment of the present invention.

FIG. 8a is a table diagram representing payer centric spend scores and criteria for determining a payer centric spend score in accordance with an exemplary embodiment of the present invention;

FIG. 8b is a table diagram representing payer centric frequency scores and criteria for determining a payer centric frequency score in accordance with an exemplary embodiment of the present invention;

FIG. 8c is a table diagram representing network spend scores and criteria for determining a network spend score in accordance with an exemplary embodiment of the present invention;

FIG. 8d is a table diagram representing network frequency scores and criteria for determining a network frequency score in accordance with an exemplary embodiment of the present invention;

FIG. 8e is a table diagram representing weight factors to apply to in accordance with an exemplary embodiment of the present invention;

FIG. 8f is a table diagram representing rate tiers to apply to in accordance with an exemplary embodiment of the present invention;

FIG. 9a is a table diagram representing data elements stored in, and relationships between data elements stored in, a payment instruction file in accordance with a first exemplary embodiment of the present invention;

FIG. 9b is a table diagram representing data elements stored in, and relationships between data elements stored in, a payment instruction file in accordance with a second exemplary embodiment of the present invention;

FIG. 9c is a table diagram representing data elements stored in, and relationships between data elements stored in, a payment instruction file in accordance with a third exemplary embodiment of the present invention;

FIG. 9d is a table diagram representing data elements stored in, and relationships between data elements stored in, a payment instruction file in accordance with a fourth exemplary embodiment of the present invention;

FIG. 10a is a ladder diagram representing a combination of data structures and instructions stored in memory and executed by a processor for making payments from each payer of a community of payers to each vendor of a community of vendors, all in accordance with an exemplary embodiment of the present invention;

FIG. 10b is a ladder diagram representing a combination of data structures and instructions stored in memory and executed by a processor for making payments from each payer of a community of payers to each vendor of a community of vendors, all in accordance with an exemplary embodiment of the present invention;

FIG. 11 is a graphic depicting an exemplary user interface for funding amount approval in accordance with and exemplary embodiment of the present invention;

FIG. 12 is a flow chart representing instructions stored in memory and executed by a processor for calculating a variable transaction fee in accordance with an exemplary aspect of the present invention;

FIG. 13 is a table diagram representing data elements stored in, and relationships between data elements stored in, an electronic funds transfer file in accordance with an exemplary embodiment of the present invention;

FIG. 14 is a flow chart representing instructions stored in memory and executed by a processor for populating records of an electronic funds transfer file in accordance with an exemplary aspect of the present invention;

FIG. 15 is a flow chart representing instructions stored in memory and executed by a processor for populating records of an operator fee transaction in accordance with an exemplary aspect of the present invention; and

FIG. 16 is a flow chart representing instructions stored in memory and executed by a processor for populating records of revenue share transaction in accordance with an exemplary aspect of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code/instructions which is encoded within computer readable medium accessible to the processor, or a combination of a hardware circuit(s) and a processor or control block of an integrated circuit executing machine readable code encoded within a computer readable medium. As such, the term circuit, module, server, application, or other equivalent description of an element as used throughout this specification is intended to encompass a hardware circuit (whether discrete elements or an integrated circuit block), a processor or control block executing code encoded in a computer readable medium, or a combination of a hardware circuit(s) and a processor and/or control block executing such code.

It should also be appreciated that table structures represented in this application are exemplary data structures only, of a non transitory nature embodied in computer readable medium, and intended to show the mapping of relationships between various data elements. Other table structures, data objects, structures, or files may store similar data elements in a manner that maintains the relationships useful for the practice of the present invention.

Within this application the applicant has depicted and described groups of certain elements. As used in this application, the term group (and the term community) means at least three of the elements. For example, a group of vendors means at least three vendors. When a group, for example a first group, is referred to as being distinct, or distinct from a second group, it means that the first group contains at least one element that is not present in the second group and the second group includes at least one element that is not present in the first group. The use of the term unique with respect to an element within a group or set of elements means that that the element is different then each other element in the set or group.

Within this application, the applicant has used the term database to describe a data structure which embodies groups of records or data elements stored in a volatile or non volatile storage medium and accessed by an application, which may be instructions coded to a storage medium and executed by a processor. The application may store and access the database.

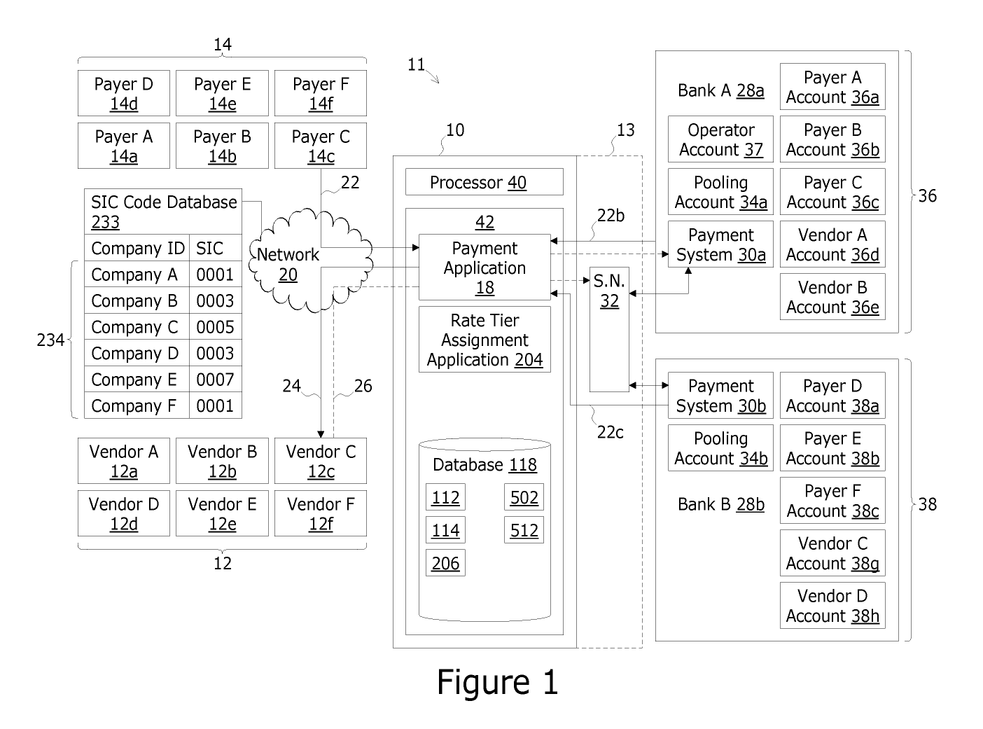

Turning to FIG. 1, an exemplary architecture 11 is shown in which a payment system 10 executes payments from each payer 14a-14f of a community of payers 14 to each vendor 12a-12f of a community of vendors 12 wherein the community of payers 14 comprises multiple distinct subgroups of payers, each subgroup being mutually exclusive of other subgroups. Each subgroup is associated with a distinct bank of a group of participating banks. For example, a first subgroup of payers 14a, 14b, 14c, all of which may be customers of participating bank 28a, are associated with bank 28a. A second subgroup of payers 14d, 14e, 14f, all of which may be customers of participating bank 28b, are associated with bank 28b.

The system 10 may further assess a transaction fee to each vendor in conjunction with executing a payment from a payer to the vendor. The transaction fee assessed to the vendor is based on a variable transaction rate. More specifically, the fee is the product of multiplying the amount of the payment by the rate that is applicable to payments made by the particular payer to the particular vendor. The rate is referred to as “variable” because: i) the rate is variable amongst vendors, the same payer may use different rates for different vendors; and ii) the rate is variable amongst payers, the same vendor may be subjected to different rates, based on the particular payer making the payment.

The transaction fee may be paid to the operator of the system 10 as an operator fee. Further, a portion of the transaction fees assessed on payments made by each payer may be paid, as variable revenue share, or variable rebate payment to the participating bank with which the payer is associated, or to the payer.

The system 10 is communicatively coupled to each payer 14a-14f of the community of payers 14 and to each vendor 12a-12f of the community of vendors 12 via an open network 20 such as the public internet.

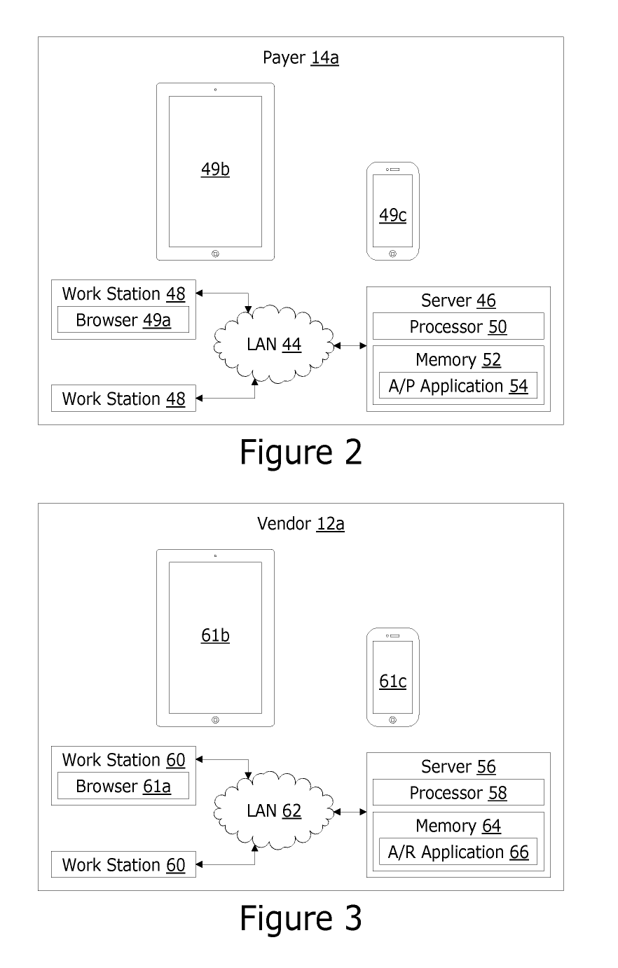

Turning briefly to FIG. 2 in conjunction with FIG. 1, in an exemplary embodiment, each payer, using payer 14a for example, may be a business that includes at least one computer system or server 46. The computer system(s) or server(s) 46 include at least one processor 50 and associated computer readable medium 52 programmed with an accounts payable application 54.

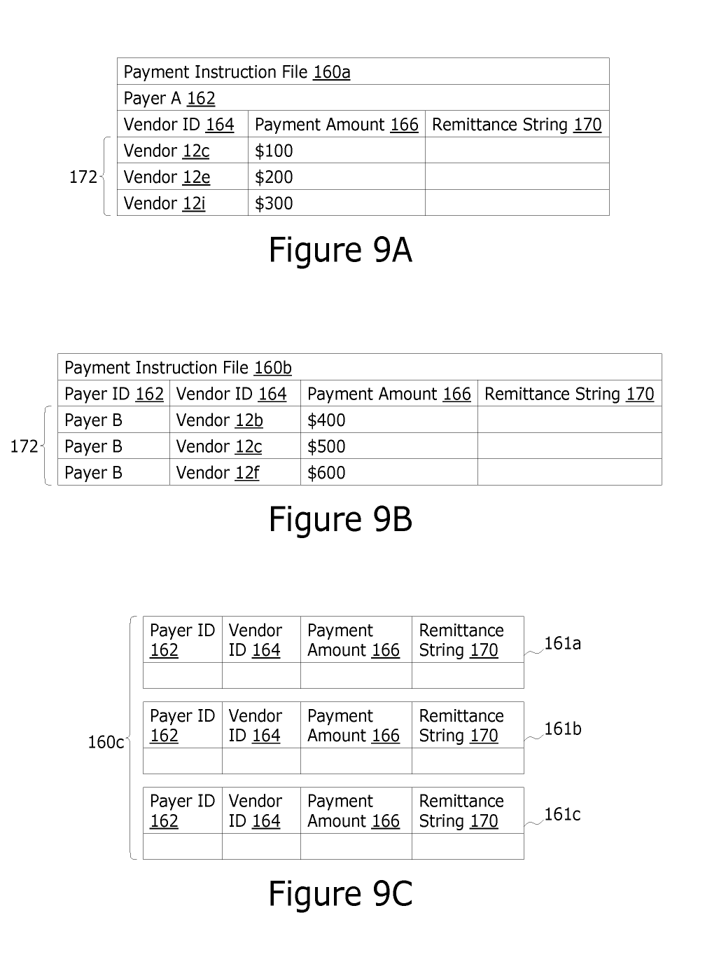

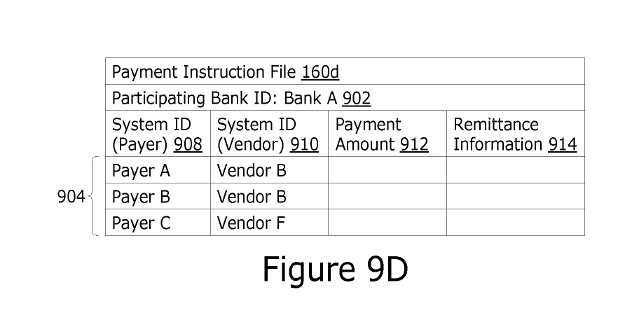

In a typical environment, the computer system(s) or server(s) 46 operating the accounts payable application 54 may be coupled to a local area network 44 and accessed by entitled users of workstations 48 and may be used for managing the payer's accounts payables and issuing payments to its vendors. The accounts payable application 54 may issue the payment instructions and/or payment instruction files described with respect to FIGS. 9a, 9b, and 9c.

Each payer, again using payer 14a as an example, may further include one or more access systems for interfacing with the system 10. Exemplary access systems include: i) a web browser 49a on a workstation or other computer which accesses system 10 via a web connection; ii) a table computer 49b such as an iPad which accesses the system 10 utilizing a custom client application on the tablet; and iii) other mobile devices 49c such as smart phones which access the system 10 utilizing a custom client application on the mobile device, in each case over permutations of the internet, wired or wireless internet service provider networks, and a local area network.

Turning briefly to FIG. 3 in conjunction with FIG. 1, in an exemplary embodiment, each vendor, using vendor 12a for example, may be a business that includes at least one computer system or server 56. The computer system(s) or server(s) 56 include at least one processor 58 and associated computer readable medium 64 programmed with an accounts receivable application 66.

In a typical environment, the computer system(s) or server(s) 56 operating the accounts receivable application 66 may be coupled to a local area network 62 and accessed by entitled users of workstations 60 and may be used for managing the vendor's accounts receivables and reconciling payments issued by customers (i.e. payers) against amounts due to the vendor.

Each vendor, again using vendor 12a as an example, may further include one or more access systems for interfacing with the system 10. Again, exemplary access systems include: i) a web browser 61a on a workstation or other computer which accesses system 10 via a web connection; ii) a table computer 61b such as an iPad which accesses the system 10 utilizing a custom client application on the tablet; and iii) other mobile devices 61c such as smart phones which access the system 10 utilizing a custom client application on the mobile device, in each case over permutations of the internet, wired or wireless internet service provider networks, and a local area network.

Returning to FIG. 1, for purposes of illustrating the invention, two of the group of participating banks 28a and 28b are depicted. Each bank, for example bank 28a, may include a payment system 30a (i.e. instructions coded to a computer readable medium and executed by a processor) which manages deposit accounts 36, including execution of credit and debit transactions to deposit accounts 36 in a traditional manner. Similarly bank 28b may include a payment system 30b (i.e. instructions coded to a computer readable medium and executed by a processor) which manages deposit accounts 38, including execution of credit and debit transactions to deposit accounts 38 in a traditional manner.

The payment system 30a, 30b of each bank 28a, 28b may further be coupled to a settlement network 32 which transfers funds between banks for settlement of payments between accounts a different banks. Exemplary settlement networks include the National Automated Clearing House Association (NACHA) for settling ACH transactions and the Federal Reserve for settling wire transactions. The settlement network may also be a card payment system operator such as American Express or a bank card brand provider—or an association, such as bank card brand providers Visa or MasterCard, which settles payments typically referred to as card payments.

Each bank may include, and each banks payment system 30a, 30b may also manage, multiple customer accounts 36 (for bank 28a) and 38 (for bank 28b). Each customer account is an account to which credit and debit transactions are posted representing credits and debits to the funds of a particular customer associated with the account (i.e. the account holder).

For example, bank 28a may have a customer account 36a for Payer 14a, a customer account 36b for payer 14b, a customer account 36c for payer 14c, a customer account 36d for vendor 12a, a customer account 36e for vendor 12b.

For example, bank 28b may have a customer account 38a for payer 14d, a customer account 38b for payer 14e, a customer account 38c for payer 14f, a customer account 38d for vendor 12c, a customer account 38e for vendor 12d.

Each customer account for a payer may be a deposit account such as a commercial checking account. Each customer account for a vendor may be a deposit account such as a commercial checking account or a merchant services account such as an account funded upon settlement of a card payment transaction.

Each participating bank 28a, 28b may further include, and the banks' payment system 30a may further manage, a settlement or pooling account 34a, 34b which may be a fiduciary consolidation account with legal title to funds therein belonging to the bank, such as a commercial checking account, to which credits and debit transactions are posted representing credits to fund payments to be issued by payers and debits to disburse payment to vendors.

For purposes of illustrating this invention, bank 28a may further include, and the banks' payment system 30a may further manage, an operator account 37 which may be a deposit account, such as a commercial checking account, to which credits and debit transactions are posted representing credits and debits to funds of the operator of the system 10.

In an exemplary embodiment, the payment system 10 may be communicatively coupled to each payment system 30a, 30b of each participating bank 28a, 28b. In another exemplary embodiment, the payment system 10 may further be coupled to the settlement network 32, or may alternatively be coupled to the settlement network 32 in lieu of being coupled to a payment systems 30a, 30b of a participating banks 28a, 28b.

In yet another exemplary embodiment, the settlement network 32 may be part of the payment system 10 as depicted by the dashed line 13 in FIG. 1. For example, if the payment system 10 is operated by a bank card association the payment system 10 may include a proprietary settlement network 32.

The payment system 10 may be a computer system of one or more servers comprising at least a processor 40 and computer readable medium 42. The computer readable medium may include encoded thereon a payment application 18, a rate tier assignment application 204, and database 118. Each of the payment application 18 and rate tier assignment application 204 may be a computer program comprising instructions embodied on computer readable medium 42 and executed by the processor 40. The database 118 may include data structures, also referred to as tables, as described herein.

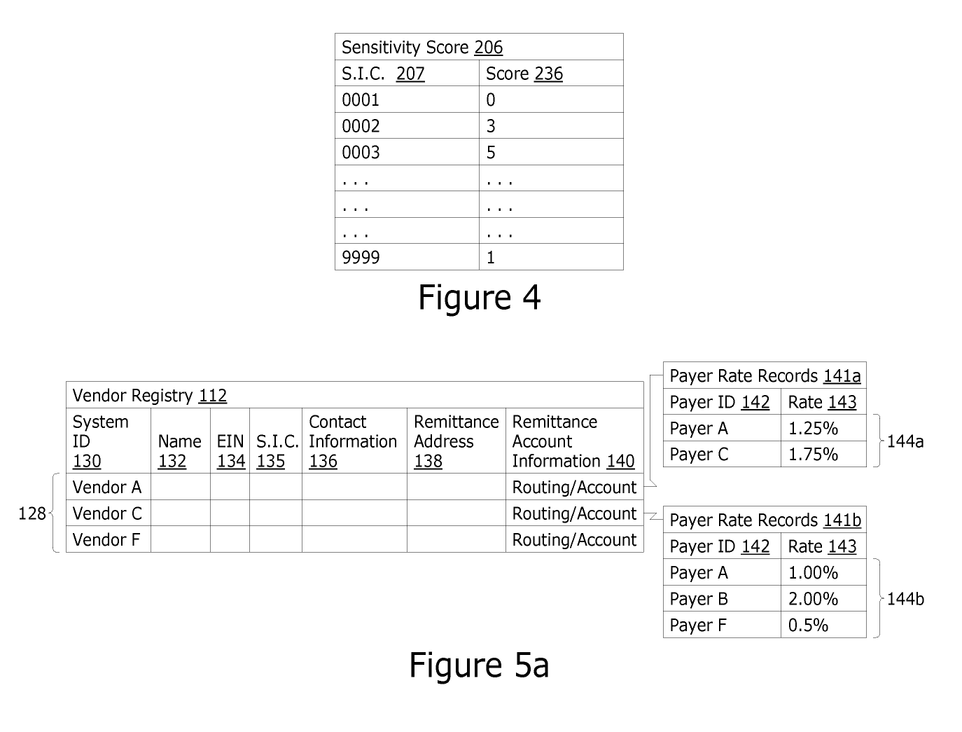

Referring to FIG. 4 in conjunction with FIG. 1, the database 118 may include, as one of its data structures, sensitivity score table 206. The sensitivity score table 206 may associate each industry code of a group of industry codes 207 to a sensitivity score 236. The group of industry codes 207 may be the four digit Standard Industrial Classification (SIC) code promulgated by the US Government; the six digit North American Industry Classification System (NAICS) code promulgated by the US Government, or the codes of any other industry classification system which utilizes alpha numeric characters or other code values to classify industries and commercial activities.

The sensitivity score 236 assigned to each industry code may be one of a group of discrete score values such as score values 1, 2, 3, 4, and 5 which represents how sensitive typical participants in such industry are to a fee charge related to receipt of payments. This measure or sensitivity may be determined based on evaluations of historical information related to industry participants accepting fees or other empirical evaluations or methods of study.

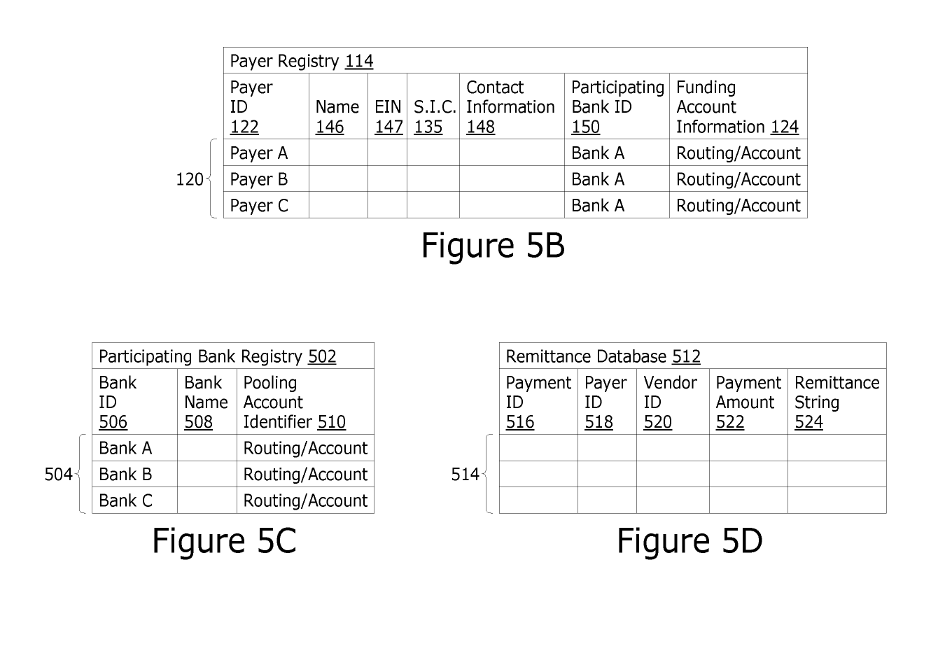

Turning briefly to FIG. 5a in conjunction with FIG. 1, the database 118 may further include, as one of the data structures, a vendor registry 112. The vendor registry 112 may comprise a group of vendor records 128. The group of vendor records 128 may comprise unique records, each of which is associated with, and identifies, a unique one of the vendors of the community of vendors 12 by inclusion of a unique system ID (for example, Vendor A, Vendor B, and Vendor C) within a system ID field 130 of the record.

Also associated with the vendor may be: i) the vendors name included in a name field 132; ii) the vendor's tax identification number included in a tax ID field 134; iii) the vendor's industry code 135; iv) the vendor's contact information included in a contact information field 136; v) the vendors remittance address included in a remittance address field 138; and vi) the vendors remittance account identifier included in a remittance account identifier field 140.

The vendor's name 132 may be the official name of the entity as recorded in official records of the jurisdiction in which it is formed and as used for titling its bank accounts, including its remittance account.

The vendor's industry code 135 may be the code of the group of industry codes 207 which represents the industry or commercial activity in which the vendor participates.

The vendor's remittance address 138 may be an address the vendor typically uses for receiving checks from its customers by regular mail (for example a lock box address).

The vendor's contact information 136 may include the name of an individual in the vendor's accounts receivable department responsible for managing the vendor's accounts receivable matters with the payers 22.

The vendor's remittance account identifier 140 may identify the bank at which the vendor's remittance account is held, such as by an ABA routing number, an account number, and/or other information needed by the payment system 30 and/or settlement network 32 to execute deposits to the vendor's account in accordance with payment authorization instructions provided by a payer.

Each record 128 of the vendor registry 112 may further associate with a unique group of payer rate records 141a, 141b. The unique group of rate records 141 associated with a record 128 of the vendor registry identifies, for that vendor identified in the record 128, those payers which make payment to the vendor and the payer specific transaction rate to apply to payments from the payer to the vendor. For example the record 128 associated with Vendor A may associate with payer rate records 141a. The payer rate records 141a include: i) a record with Payer A populated to the Payer ID field 142 and 1.25% populated to the rate field 143 indicating that a transaction fee rate of 1.25% applies to payments made by Payer A to Vendor A; and ii) a record with Payer C populated to the Payer ID field 142 and 1.75% populated to the rate field 143 indicating that a transaction fee rate of 1.75% applies to payments made by Payer C to Vendor A.

Similarly, the record 128 associated with Vendor C may associate with payer rate records 141b. The payer rate records 141b include: i) a record with Payer A populated to the Payer ID field 142 and 1.00% populated to the rate field 143 indicating that a transaction fee rate of 1.00% applies to payments made by Payer A to Vendor C; ii) a record with Payer B populated to the Payer ID field 142 and 2.00% populated to the rate field 143 indicating that a transaction fee rate of 2.00% applies to payments made by Payer B to Vendor A; and iii) a record with Payer F populated to the Payer ID field 142 and 0.50% populated to the rate field 143 indicating that a transaction fee rate of 0.50% applies to payments made by Payer F to Vendor C. It should be appreciated that the rate on payments from Payer A to Vendor A is different than the rate on payments from Payer A to Vendor C.

Turning to FIG. 5b in conjunction with FIG. 1, the database 118 may include a payer registry 114. The payer registry 114, may comprise a group of payer records 120. Each record 120 is associated with, and identifies a unique one of the payers 14a-14f of the community of payers 14 by inclusion of a unique system ID (for example Payer A, Payer B, Payer C) within a system ID field 122 of the record.

Also associated with the Payer may be: i) the payer's name included in a name field 146; ii) the payer's tax identification number included in a tax ID field 147; iii) the payer's contact information included in a contact information field 148; v) identification of the participating bank with which the payer is associated in a participating bank field 150; and vi) the payer's transaction or funding account identifier included in a funding account information field 124.

The payer's name 146 may be the official name of the entity as recorded in official records of the jurisdiction in which it is formed and as used for titling its bank accounts, including its funding account.

The payer's contact information 148 may include the name of an individual in the payer's accounts payable department responsible for managing the payer's accounts payable matters with the vendors 12.

The participating bank identifier may be a character string identifying the bank—such as the bank's name or ABA routing number.

The payer's funding account identifier 140 may identify the bank at which the payer's funding account is held (which is not necessarily the participating bank with which the payer is associated) such as by an ABA routing number, an account number, and/or other information needed by the payment system 20 and/or settlement network 32 to execute transactions to fund the participating bank's pooling account 34a, 34b from the payer's funding account in accordance with payment authorization instructions provided by a payer.

Turning to FIG. 5c in conjunction with FIG. 1, the database 118 may include a participating bank registry 502. The participating bank registry 502 may comprise a group of bank records 504. Each record 504 is uniquely associated with, and uniquely identifies, one of the participating banks of the group of participating banks by identification of a unique bank ID (for example Bank A, Bank B, Bank C) in a bank ID field 506 of the record. Each record also includes a bank name field 503 and a pooling account identifier field 510.

The bank's name may be the official name of the bank as recorded in official records of the jurisdiction in which it is formed.

The pooling account identifier may identify the bank such as by an ABA routing number, an account number, and/or other information needed by the payment system 20 and/or settlement network 32 to execute transactions to fund the pooling account in accordance with payment authorization instructions provided by a payer.

Turning to FIG. 5d in conjunction with FIG. 1, the database 118 may include a remittance database 512. The remittance database 512 may comprise a group of bank records 514. Each record 514 is uniquely associated with, and uniquely identifies, a single payment from a payer to a payee. The record 414 includes the unique system ID identifying the payment in a payment ID field 516, identification of the payer making the payment by inclusion of the payer's unique system ID in a payer ID field 518, identification of the vendor receiving the payment by inclusion of the unique system ID of the vendor in a vendor ID field 520, the amount of the payment in a payment amount field 522, and remittance information in a remittance string field 524.

The remittance information may identify the vendor's invoice being paid, goods or services for which payment is being made, or other aspects of an underlying transaction between the payer and vendor giving rise to the payment associated with the record.

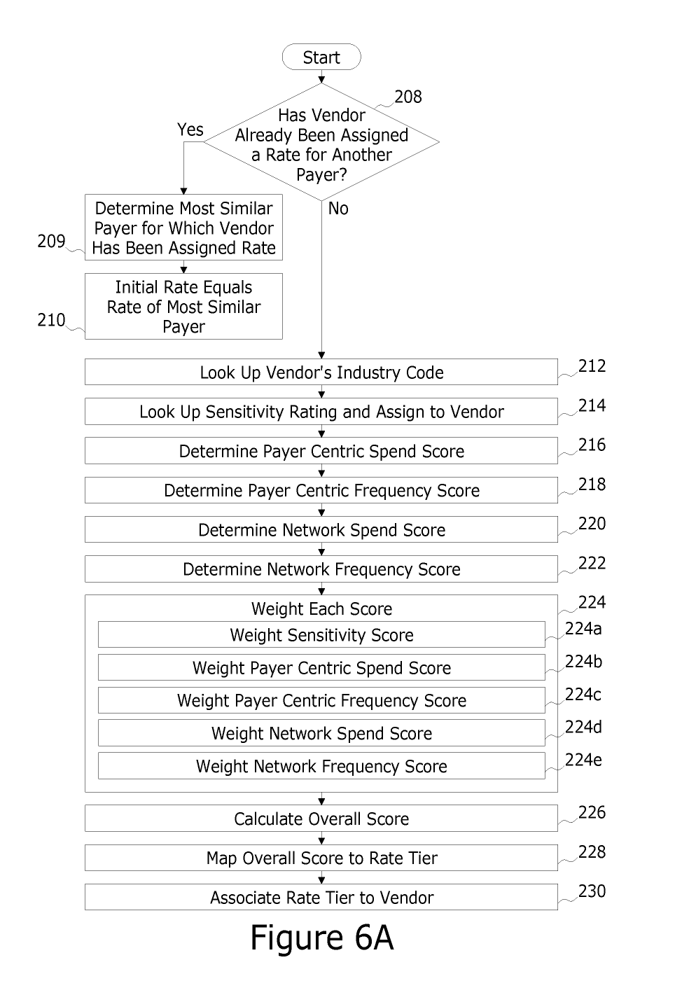

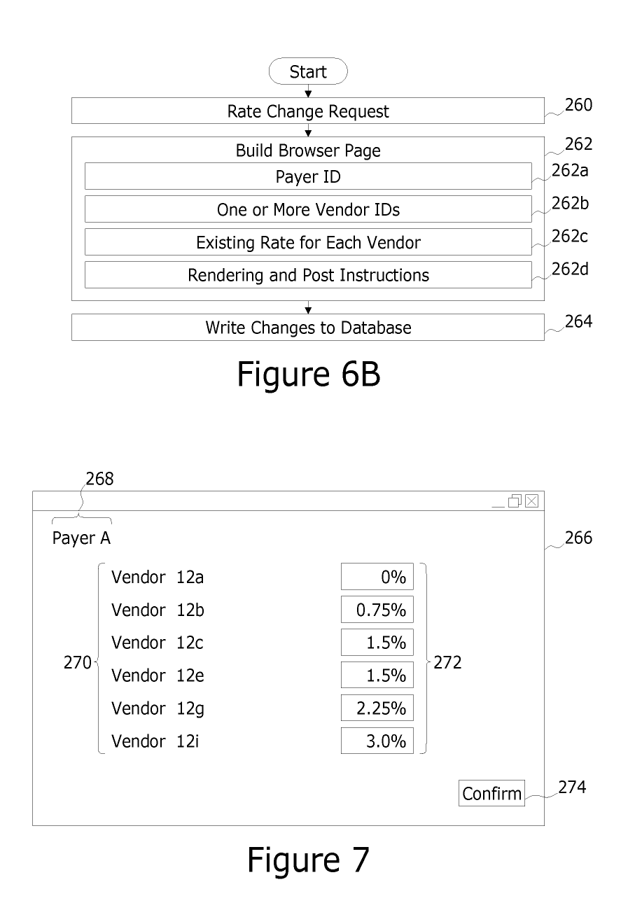

Turning to FIG. 6a, exemplary steps performed by the rate tier assignment application 204 to assign, for a prospective payer, an initial payer specific rate to a vendor are shown. Step 208 represents determining whether the vendor has already been assigned a rate by another payer. If the vendor has already been assigned a rate by one or more other payers (i.e. payer rates are populated into the payer rate records 141 associated with the vendor in the vendor registry 112, FIG. 5a), the rate tier assignment application 204 determines which of the one or more other payers has the most similar payer/vendor relationship with the vendor as the prospective payer at step 209.

More specifically, if the vendor has an assigned rate for only one other payer, that one payer would be the payer with the most similar payer/vendor relationship. If the vendor has an assigned rate with more than one payer, the other payer which pays the vendor the most similar annual payment volume and the most similar payment frequency would be the payer with the most similar payer/vendor relationship.

At step 210, the rate assigned to the vendor, for payments by the prospective payer, would be the same rate that is in effect with the most similar other payer.

Alternatively, if at step 208 it is determined that the vendor has not already been assigned a rate for payments by any other payers (i.e. no payer/rate combinations are populated to the payer rate records 141 in association with the vendor in the vendor registry 112 of FIG. 5a), the rate assignment application 204 executes steps 212 through 230 to assign an initial rate.

Step 212 represents determining the vendor's industry code. The rate tier assignment application 204 may determine the vendor's industry code by retrieving it from the industry code field 135 of the record associated with the vendor in the vendor registry 112 (FIG. 5a). Alternatively, with reference to FIG. 1 in conjunction with FIG. 5a, if the vendor's industry code is not available in the vendor registry 112, the rate tier assignment application 204 may query a SIC code database 233.

The SIC code database 233 may associate the name of each company within a group of companies 234 with the company's industry code. Each company may be identified by its name, tax ID number, or other identifier. In querying the SIC code database 233, the rate tier assignment application may provide the vendor's name, tax ID number, or other identifier and receive, in response, the vendors industry code.

The SIC database 233 may be a remote database accessible over the internet 20 as depicted in FIG. 1, a local database coupled to the system 10, or a local database that is part of database 118 of system 10.

Returning to FIG. 6a, step 214 represents determining the vendor's industry sensitivity score by looking up the industry sensitivity score 236 associated with the vendor's industry code in the sensitivity score table 206 (FIG. 4).

Step 216 represents determining the vendor's payer centric spend score. The vendor's payer centric spend score is a function of the aggregate value of all payments expected to be made by a particular payer, for example payer 14a, to the vendor over a predetermined period of time, such as one calendar year and may be an integer value of one (1) through five (5).

The aggregate amount of payments expected to be made by the particular payer to the vendor over the one year period may be determined based on historical payment information, such as the aggregate amount of payments made by the particular payer to the vendor over the previous year.

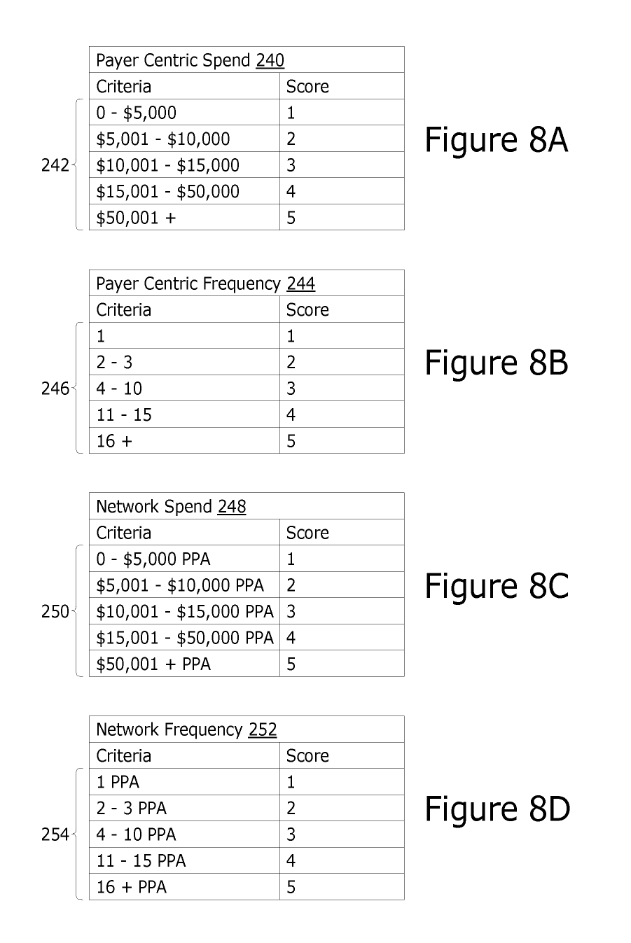

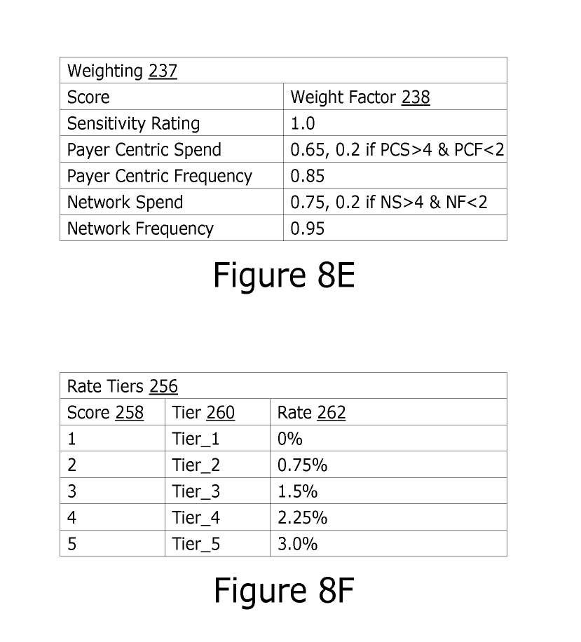

Referring briefly to FIG. 8a in conjunction with FIG. 1, in an exemplary embodiment, the rate tier assignment application 204 may maintain a payer centric spend table 240 (which may be embodied in computer readable medium) which includes a record 242 associated with each score value 1-5. The record designates criteria for assigning the score value. In the exemplary embodiment: i) a score value of 1 is assigned if the aggregate amount of payments expected to be made by the particular payer to the vendor over a one year period is less than or equal to $5,000; ii) a score value of 2 is assigned if the aggregate amount of payments expected to be made by the particular payer to the vendor over a one year period is between $5,001 and $10,000; iii) a score value of 3 is assigned if the aggregate amount of payments expected to be made by the particular payer to the vendor over a one year period is between $10,001 and $15,000; iv) a score value of 4 is assigned if the aggregate amount of payments expected to be made by the particular payer to the vendor over a one year period is between $15,001 and $50,000; and v) a score value of 5 is assigned if the aggregate amount of payments expected to be made by the particular payer to the vendor over a one year period is greater than $50,000.

Step 218 represents determining the vendor's payer centric frequency score. The vendor's payer centric frequency score is a function of the quantity of payments is expected to be made by a particular payer, for example payer 14a, to the vendor over a predetermined period of time, such as one calendar year and may be may be an integer value of one (1) through five (5).

The total quantity of payments expected to be made by the particular payer to the vendor over the one year period may be determined based on historical payment information, such as the total quantity of payments made by the particular payer to the vendor over the previous year.

Referring briefly to FIG. 8b in conjunction with FIG. 1, in an exemplary embodiment, the rate tier assignment application 204 may maintain a payer centric frequency table 244 (embodied in computer readable medium) which includes a record 246 associated with each score value 1-5. The record designates criteria for assigning the score value. In the exemplary embodiment: i) a score value of 1 is assigned if the total quantity of payments expected to be made by the particular payer to the vendor over a one year period is no greater than one (1); ii) a score value of 2 is assigned if the total quantity of payments expected to be made by the particular payer to the vendor over a one year period is two (2) to three (3); iii) a score value of 3 is assigned if the total quantity of payments expected to be made by the particular payer to the vendor over a one year period is between four (4) and ten (10); iv) a score value of 4 is assigned if the total quantity of payments expected to be made by the particular payer to the vendor over a one year period is between eleven (11) and fifteen (15); and v) a score value of 5 is assigned if the total quantity of payments expected to be made by the particular payer to the vendor over a one year period is greater than fifteen (15).

Step 220 represents determining the vendor's network spend score. The vendor's network spend score is a function of the aggregate value of all payments expected to be made by all payers within the group of payers 14 to the vendor over a predetermined period of time, such as one calendar year and may be may be an integer value of one (1) through five (5).

The aggregate amount of payments expected to be made to the vendor by multiple payers within the network of payers over the one year period may be determined based on historical payment information, such as the aggregate amount of payments made to the vendor by multiple payers within the network of payers over the previous year.

Referring briefly to FIG. 8c in conjunction with FIG. 1, in an exemplary embodiment, the rate tier assignment application 204 may maintain a network spend table 248 (embodied in computer readable medium) which includes a record 250 associated with each score value 1-5. The record designates criteria for assigning the score value. In the exemplary embodiment: i) a score value of 1 is assigned if the aggregate amount of payments expected to be made to the vendor by multiple payers within the network of payers over a one year period; divided by the number of payers making payment to the vendor to derive a “per payer average” results in a per payer average less than or equal to $5,000; ii) a score value of 2 is assigned if the aggregate amount of payments expected to be made to the vendor by multiple payers within the network of payers over a one year period results in a per payer average between $5,001 and $10,000; iii) a score value of 3 is assigned if the aggregate amount of payments expected to be made to the vendor by multiple payers within the network of payers over a one year period results in a per payer average between $10,001 and $15,000; iv) a score value of 4 is assigned if the aggregate amount of payments expected to be made to the vendor by multiple payers within the network of payers over a one year period results in a per payer average between $15,001 and $50,000; and v) is assigned if the aggregate amount of payments expected to be made to the vendor by multiple payers within the network of payers over a one year period results in a per payer average greater than $50,000.

Step 222 represents determining the vendor's network centric frequency score. The vendor's network frequency score is a function of the totally quantity of payments expected to be made by all payers within the group of payers 14 to the vendor over a predetermined period of time, such as one calendar year and may be may be an integer value of one (1) through five (5).

The total quantity of payments expected to be made to the vendor by multiple payers within the network of payers over the one year period may be determined based on historical payment information, such as the total quantity of payments made to the vendor by multiple payers within the network of payers over the previous year.

Referring briefly to FIG. 8d in conjunction with FIG. 1, in an exemplary embodiment, the rate tier assignment application 204 may maintain a network frequency table 252 (embodied in computer readable medium) which includes a record 254 associated with each score value 1-5. The record designates criteria for assigning the score value. In the exemplary embodiment: i) a score value of 1 is assigned if the total quantity of payments expected to be made to the vendor by multiple payers within the network of payers; divided by the number of payers making payment to the vendor to result in a “per payer average” results in a per payer average of one (1); ii) a score value of 2 is assigned if the total quantity of payments expected to be made to the vendor by multiple payers within the network of payers results in a per payer average of two (2) to three (3); iii) a score value of 3 is assigned if the total quantity of payments expected to be made to the vendor by multiple payers within the network of payers results in a per payer average of four (4) and ten (10); iv) a score value of 4 is assigned if the total quantity of payments expected to be made to the vendor by multiple payers within the network of payers results in a per payer average of eleven (11) and fifteen (15); and v) a score value of 5 is assigned if the total quantity of payments expected to be made to the vendor by multiple payers within the network of payers results in a per payer average of sixteen (16) or greater. In all cases fractional values may be rounded to the nearest integer value, rounded up to the nearest integer value, or rounded down (i.e. truncated) to the nearest integer value.

Returning to FIG. 6a, step 224 represents weighting each score. Referring to the weighting table of FIG. 8e, each score, as determined at steps 214 through 222 is multiplied by a weight factor 238 to determine a weighted score.

More particularly, at step 224a, the sensitivity score is weighted (or multiplied by) a factor of 1.0 to determine a weighted industry sensitivity score.

At step 224b the payer centric spend score is weighted by a factor of 0.65 to determine a weighted payer centric spend score. Provided however, in the event the payer centric spend score is greater than four (4) and the payer centric frequency score is less than two (2), the payer centric spend score is weighted by a factor of 0.2 to determine the weighted payer centric spend score.

At step 224c the payer centric frequency score is weighted by a factor of 0.85 to determine a weighted payer centric frequency score.

At step 224d the network spend score is weighted by a factor of 0.75 to determine a weighted network spend score. Provided however, in the event the network spend score is greater than four (4) and the network frequency score is less than two (2), the network spend score is weighted by a factor of 0.2 to determine the weighted network spend score.

At step 224e the network frequency score is weighted by a factor of 0.95 to determine a weighted network frequency score.

Step 226 represents calculating an overall score. The overall score is the average of the weighted industry sensitivity score, the weighted payer centric spend score, the weighted payer centric frequency score, the weighted network spend score, and the weighted network frequency score. It should be appreciated that each weight factor associated with each score may be distinct from other weight factors associated with other scores.

Step 228 represents determining the rate to initially assign to the vendor by mapping the overall score to a rate tier. Referring to FIG. 8f, examples of how the mapping may be performed include: i) rounding the overall score to the closest rate tier score value 258, for example overall score of 2.51 maps to rate Tier_{—}3; and ii) truncating the overall score to the closest rate tier value, for example overall score of 2.51 maps to rate Tier_{—}2.

Step 230 represents associating the rate applicable to payments made by the payer to the vendor by: i) writing a new record 144 to the payer rate records 141 associated with the vendor, such new record including the system ID of the payer in the payer ID field 142 and the rate in the rate field 143.

It should be appreciated that the steps represented by FIG. 6a represent the exemplary embodiment wherein the overall score and the rate assigned for payments by the payer to the vendor are a function of all of the vendor's industry score, payer centric spend score, payer centric frequency score, network spend score, and network frequency score. The scope of the present invention includes determining the overall score and rate assignment as a function of permutations of one or more of any of these scores.

For example, determining the rate based on: i) industry score only (permutation of only one score), ii) industry score, payer centric spend score, and payer centric frequency score (permutation of three scores); and iii) industry score, network spend score, and network frequency score (a different permutation of three scores). When permutations of fewer than all scores are used, the weighted average is based on only those scores that are used.

Turning to FIG. 6b, the rate tier assignment application 204 further includes steps which, when executed by the processor permit a rate assigned to a vendor (for a prospective payer) to be altered by, or at the direction of, the prospective payer.

Step 260 represents a rate change request being provided to the rate tier assignment application 204. In response, the rate tier assignment application 204 builds a render-able object which permits the rate to be altered.

FIG. 7 depicts an exemplary render-able object 266, in graphic form. Referring to FIG. 6b and FIG. 7, step 262 represents populating the payer ID 268 of the prospective payer to the render-able object 266. Step 262b represents populating one or more vendor IDs 270 to the render-able object 266, each vendor ID being for a vendor within the prospective payer's payer vendor group. Step 262c represents populating the existing rate applicable to payments made by the payer to each such vendor as such rates are recorded in the payer rate records 141 associated with the vendor (FIG. 5a).

Step 262d represents populating rendering instructions which may be code necessary for a payer system 49a, 49b, 49c (FIG. 2) to render the render-able object 266 in graphic format and post user entered changes to the existing rate 272 back from the system 49a, 49b, 49c to the rate assignment application 204 in response to user action such as clicking a confirm button 274. Upon receipt of such a post, the rate assignment application 204 writes, at step 263, the updated rates to the applicable fields of payer rate records 141 (FIG. 5a).

Turning to FIG. 1, in operation, the payment system 10 processes payments, each payment being initiated by one of the payer's within the community of payers 14, for payment of a payment amount from the payer's account to one of the vendors within the community of vendors 12. More specifically the payment system 10 receives a payment instruction file identifying payments to process for the payer.

For example, arrow 22a represents receipt of a payment instruction file from payer 14c identifying payments to process for payer 14c, the payments being payments to a group of vendor's to which payer 14c makes payment. Arrow 22b represents receipt of a payment instruction file from participating bank 28a identifying payments to process for one or more payers of the subgroup of payers associated with participating bank 28a. Arrow 22c represents receipt of a payment instruction file from participating bank 28b identifying payments to process for one or more payers of the subgroup of payers associated with participating bank 28b.

Referring to FIG. 9a a first exemplary payment instruction data structure, or payment instruction file, that would be received from a payer 14 is depicted. Referring to FIG. 1 in conjunction with FIG. 9a, the payment instruction file 160a may comprises identification of the payer within a payer ID field 162 (Payer ID “Payer A” representing payer 14a) and, associated with that payer ID field 152, a group of unique records 172, each record representing a unique payment instruction. Each record 172 includes: i) identification of the vendor to which payment is to be made by inclusion of the vendor's Vendor ID (from the vendor registry 112) within a vendor ID field 164; ii) identification of the amount of the payment to be made to the vendor by inclusion of a payment amount within a payment amount field 166; and iii) remittance information, which may be alpha numeric information identifying what payable is being paid, within a remittance string field 170. The remittance information may identify the vendor's invoice being paid, goods or services for which payment is being made, or other aspects of an underlying transaction between the payer and vendor giving rise to the payment associated with the record.

FIG. 9b represents a second exemplary payment instruction data structure, or payment instruction file that would be received from a payer 14. Referring to FIG. 1 in conjunction with FIG. 9b, the payment instruction file 160b may comprise a group of unique records 172, each record representing a unique payment instruction. Each record 172 includes: i) identification of the payer within a payer ID record 162 (i.e. Payer ID “Payer B” representing payer 14b)); ii) identification of the vendor to which payment is to be made by inclusion of the vendor's Vendor ID (from the vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the payer and vendor giving rise to the payment associated with the record.

FIG. 9c represents a third exemplary payment instruction data structure, or payment instruction file that would be received from a payer 14. Referring to FIG. 1 in conjunction with FIG. 9c, a group of independent payment instructions, comprising unique payment instructions 161a, 161b and 161c, may in the aggregate be a payment instruction file 160c.

Each payment instruction may include: i) identification of the payer within a payer ID record 162; ii) identification of the vendor to which payment is to be made by inclusion of the vendor's Vendor ID (from the vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the payer and vendor giving rise to the payment associated with the record.

FIG. 9d represents a fourth exemplary payment instruction data structure, or payment instruction file—of a type which may be received from a participating bank 28a, 28b. Referring to FIG. 1 in conjunction with FIG. 9d, the payment instruction file 160d may comprise identification of the participating bank 902 (such as by name or ABA routing number) and a group of unique records 904. Each record 904 represents a unique payment instruction and includes: i) identification the system ID of a disbursing payer associated with the participating bank within a payer ID field 908 (i.e. Payer ID “Payer B” representing payer 14b)); ii) a system ID of the vendor to which payment is to be made by inclusion of the vendor's system ID within a vendor ID field 910; iii) identification of the amount of the payment to be made to the vendor by inclusion of a payment amount within a payment amount field 912; and iv) remittance information 914.

Again, the remittance information may be alpha numeric information identifying the purpose of the payment or identifying what payable is being paid; such as by identifying the vendor's invoice being paid, goods or services for which payment is being made, or other aspects of an underlying transaction between the payer and vendor giving rise to the payment associated with the record. It should be appreciated that records 904 may represent payments from different disbursing payers in the same payment instruction file 160d.

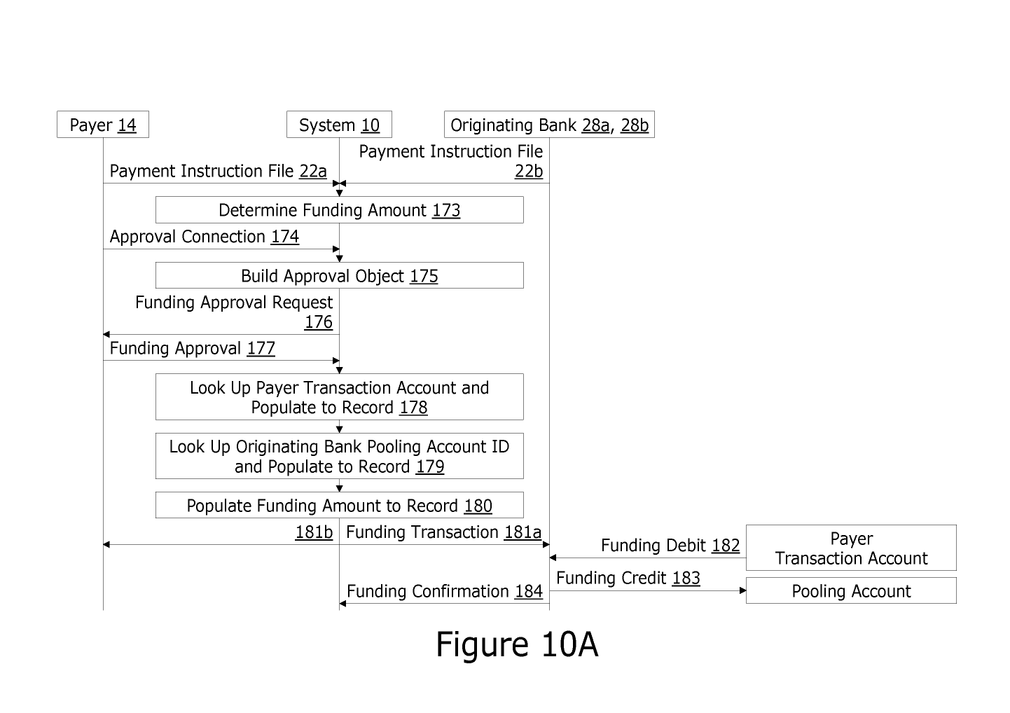

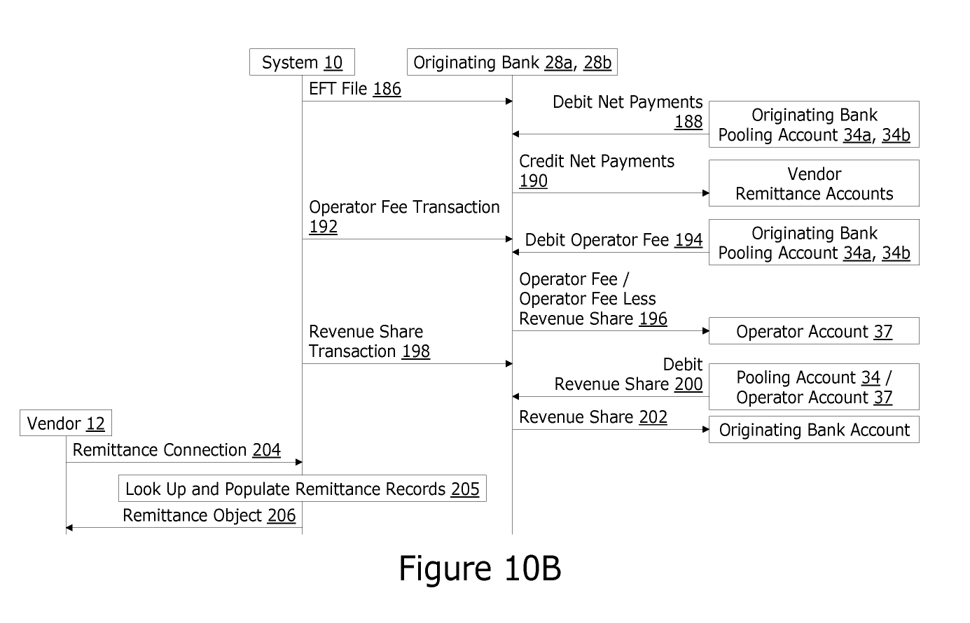

Referring to the ladder diagram of FIG. 10a in conjunction with FIG. 1, in an exemplary embodiment of operation, the payment system 10 receives a payment instruction file from either a payer 14a-14f or a participating bank 28a, 28b. For example, payment instruction file 160a (FIG. 9a) may be received from payer 14a, as represented by step 22a or payment instruction file 160d (FIG. 9d) may be received from participating bank 28a as represented by step 22b. In either case the payment instruction file 160a, 160d may be transferred via a secure connection over the network 20 which may include implementing encryption of the connection and/or the file transferred over the connection.

Upon receiving and authenticating the payment instruction file 160, the payment system 10, or more specifically, the processor 40 executing the payment application 18, determines, for the disbursing payer, or each disbursing payer, represented by records of the file 160, a funding amount at step 173. The funding amount for a disbursing payer is equal to the aggregate or sum of the amount of all payments to be disbursed by the disbursing payer as represented in the payment instruction file 160.

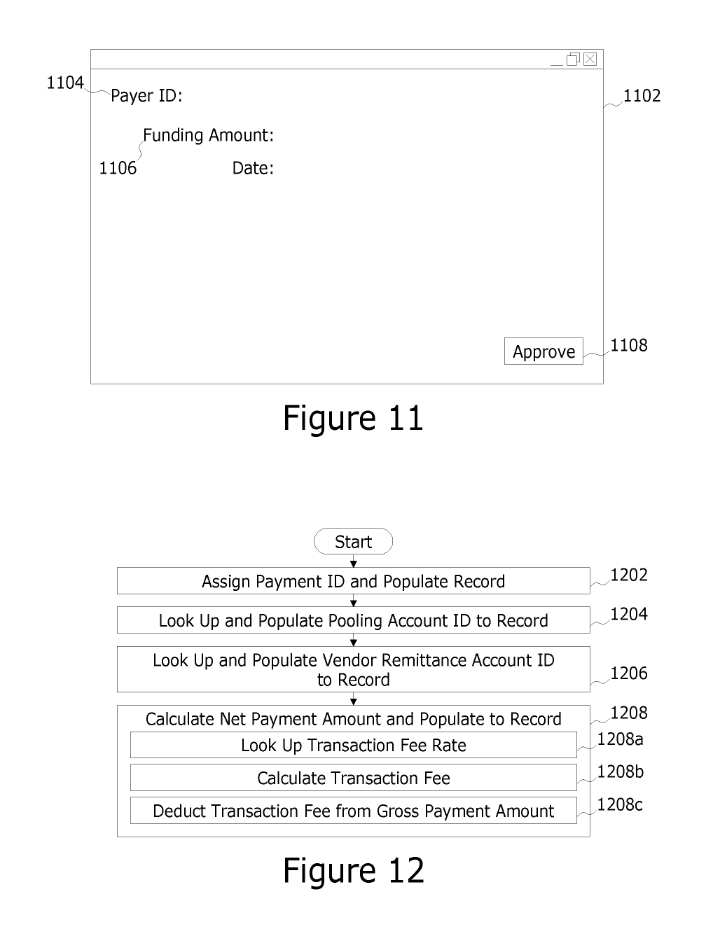

Steps 174 through 177 represent, for each disbursing payer, obtaining the disbursing payer's approval of the funding amount. More specifically, in response to each disbursing payer establishing a secure session by a payer system 49a, 49b, 49c for purposes of approving the funding total (as represented by step 174), the system 10, at step 175, generates a funding approval object (for example object 1102 as represented by FIG. 11) by looking up the funding total calculated for the disbursing payer. Step 176 represents providing the funding approval object to the payer system 49a, 49b, 49c for rendering, authentication, and approval by the payer. Step 177 represents posting of the payer's approval to the system 10.

Referring briefly to FIG. 11, the exemplary funding approval object, represented in graphic form as may be rendered on the remote payer system 49a, 49b, or 49c, may comprise a least identification of the payer 1104, identification of the funding amount 1106, and a control 1108 operational for posting the payer's approval to the system 10.

Returning to FIG. 10a, steps 178 through 180 represent generating a funding transaction to fund the transfer of the funding total from the payer's account to the pooling account of the participating bank with which the payer is associated. More specifically, generating the funding transaction comprises: i) at step 178, looking up the disbursing payer's funding account identifier in the payer registry 112 (FIG. 5b) and populating the funding account identifier to a field of the funding transaction which identifies the account to be debited; ii) at step 179, looking up the participating bank's pooling account identifier from the participating bank registry 502 and populating the pooling account identifier to a field of the funding transaction which identifies the account to be credited; and iii) at step 180, populating the approved funding amount to a field of the funding transaction which represents the amount to transfer (debit and credit).

Step 181 represents sending the funding transaction to the participating bank 28a, 28b for execution. Execution is represented by debiting the approved funding amount from the disbursing payer's transaction account at step 178 and crediting the participating bank's pooling account at step 180. Step 182 represents the participating bank confirming to the system 10 that the funding transaction is complete and that the approved amount has been deposited into the pooling account.

The debit of the payer's account and credit to the pooling account may be by funds transfer if both accounts are held at the same bank, by transfer through a settlement network 32 (for example via ACH or Wire) if the payers account and pooling account are held at different banks. As discussed, the settlement network 32 may be separate from the payment system 10, such as the Fedwire settlement network or the ACH settlement network, or may be a proprietary component of the payment system 10, such as a bank card association settlement network. In an embodiment wherein the settlement network 32 is part of the payment system 10, the settlement network 32 may be an application comprising instructions stored on the computer readable medium 42 and executed by processor 40, such instructions implementing the credit and debit transactions as described in this specification.

In a second funding embodiment, the funding instruction 181b may be a message to the payer from which the payment instruction file was received. The payer may then, accessing a payment system 30 at the payer's bank or a settlement network, initiate a debit transaction to debit the funding amount from payers account and initiation of a credit transaction to credit to pooling account of the funding amount. Again thereafter, step 182 represents the participating bank confirming to the system 10 that the funding transaction is complete and that the approved amount has been deposited into the pooling account

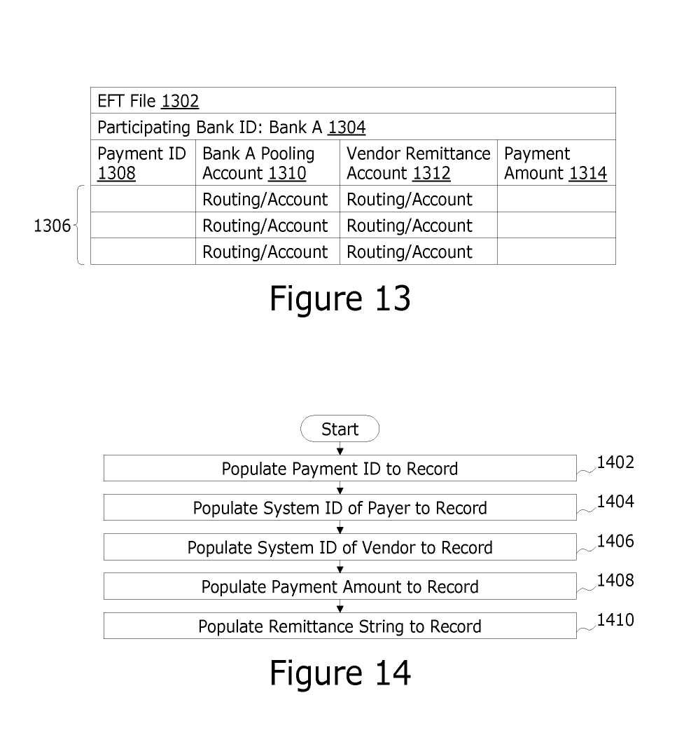

After confirmation that the funding amount from one or more payers has been received in the participating bank's pooling account, payments are disbursed to vendors. More specifically, the steps of FIG. 12 represent operation of the application 18 to generate an electronic funds transfer (EFT) file 1302 depicted in table format in FIG. 13.

The EFT file 1302 comprises a group of records 1306. Each record represents a single payment of a disbursing payer to a payee. The records of the EFT file may represents payments from multiple disbursing payers, but with all of the disbursing payers being within the same sub-group which is associated with a single participating bank 28a, 28b. The EFT file 1302 includes an identifier of that single participating bank 1304.

Each payment record 1306 includes at least: i) a payment ID field 1308 which is populated with a unique value to identify the payment; ii) a field identifying the account to be debited 1310 populated with the participating bank's pooling account identifier (i.e. ABA routing number and account number of the pooling account); iii) a field identifying the account to be credited 1312 populated with the vendor's remittance account identifier (i.e. ABA routing number and account number of the vendor's remittance account); and iv) a payment amount field 1314 populated with the amount of the payment to be debited from the participating bank's pooling account and credited to the vendor's remittance account.

Turning to FIG. 12 in conjunction with FIG. 13, generating each EFT file 1302 for each participating bank comprises, for each payment within the funding amount approved by each disbursing payer with funds on deposit in the pooling account: i) at step 1202, assigning a unique identifying value to the payment and populating it to the payment ID field 1308 of a unique record 1306; ii) at step 1204, looking up the pooling account identifier for the participating bank (in the participating bank registry 502, FIG. 5c) and populating the pooling account identifier to the field identifying the account to be debited 1310; iii) at step 1206, looking up the vendor's remittance account identifier and populating the vendor's remittance account identifier to the field identifying the account to be credited 1312; and iv) at step 1208, calculating a net payment amount and populating the net payment amount to the payment amount field 1314.

Calculating the net payment amount may comprise: i) at step 1208a, looking up, in the payer rate records 141 of the record 128 of the vendor registry 112 associated with the vendor (i.e. the record 128 with the System ID of the vendor populated to the system ID field 130) the transaction fee rate from the rate field 143 of the record 144 associated with the payer (i.e. the record 144 with the System ID of the disbursing payer populated to the payer ID field 142); ii) at step 1208b, calculating the transaction fee by multiplying the gross payment amount by the transaction fee rate; and iii) at step 1208c, deducing the transaction fee from the gross payment amount to yield the net payment amount.

Referring to FIG. 10b, after the EFT file 1302 is generated, the application 18 transfers the EFT file 1302 to the participating bank with the pooling account from which each payment in the EFT file 1302 is to be debited at step 186.

Steps 188 and 190 represent, for each payment represented in the EFT file 1302, debiting the net payment amount from the participating bank's pooling account and crediting the net payment amount to the vendor's remittance account. These steps may be accomplished by way of transferring the EFT file 1302 as disbursement instructions to the Federal Reserve such that each such payment is implemented by an electronic funds transfer commonly known as an ACH payment.

The debit(s) of the pooling account and credits to the vendor's transaction account and operator account by funds transfer if between accounts held at the same bank or by transfer through a settlement network 32 if between accounts are held at different banks.

In an alternative embodiment, the disbursements instructions 188 and 190 may each be an instruction, or a debit/credit instruction pair, sent directly by the payment application 18 the settlement network 32 (whether separate from, or part of the payment system 10) to effect the initiation of a debit transaction to debit the applicable amount from the pooling account and credit the amount of the payment less the transaction fee to the vendor account and to credit the transaction fee to the operator account.

Referring FIG. 14 in conjunction with FIG. 10b and FIG. 5d, the application 18 may executes steps 1402 through 1410 to populate a record for each payment represented in the EFT file 3102 to the remittance database 512.

More specifically, for each payment represented in the EFT file 1302: i) at step 1402, the payment identifier for the payment is populated to the payment ID field 516; ii) at step 1404, the system ID of the disbursing payer is populated to the payer ID field 518; iii) at step 1406, the system ID of the vendor is populated to the vendor ID field 520; iv) at step 1408, the gross payment amount, net payment amount, or both is/are populated to the payment amount field 522; and v) at step 1410, the remittance string from the payment instruction file, or a remittance string based on the remittance string form the payment instruction file, to the remittance string field 523.

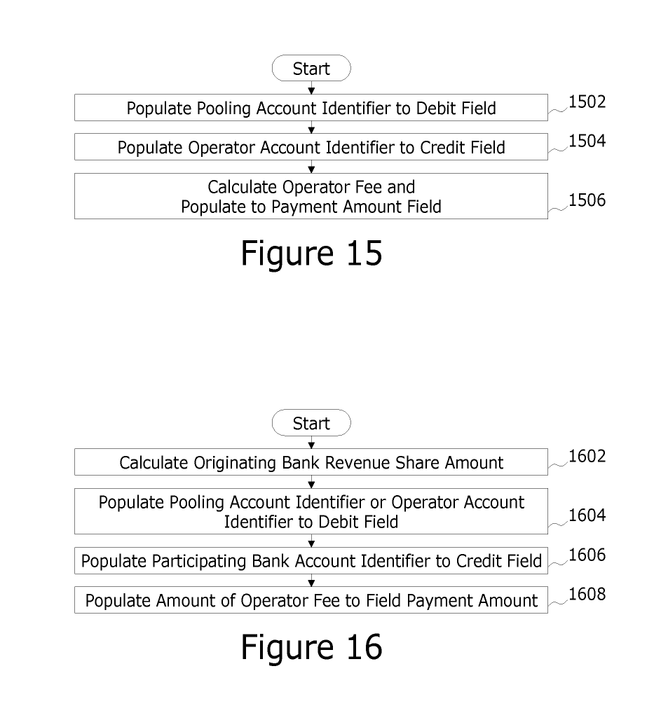

Returning to FIG. 10b, step 192 represents providing an operator fee transaction to the originating bank for processing. The operator fee transaction may be a record in the EFT file 1302 or a separate transaction. Referring to FIG. 15, generating the operator fee transaction comprises: i) at step 1502, populating the pooling account identifier to a field of the operator fee transaction which identifies an account from which an operator fee is to be debited; ii) at step 1504, populating an operator account identifier to a field of the operator fee transaction which identifies an account held by the operator of the system and to which the operator fee is to be credited; and iii) at step 1506, populating the amount of the operator fee to a payment amount field of the operator fee transaction, the amount of the operator fee being a portion of the aggregate transaction fees for each payment represented in the EFT file 1302. The portion of the aggregate transaction fees may be 100%.

Step 194 represents executing the operator fee transaction by debiting the operator fee from the pooling account and step 196 represents crediting the operator fee to the operator account 37.

Returning to FIG. 10b, step 198 represents providing a revenue transaction to the originating bank for processing. A revenue share transaction is provided typically in circumstances where the operator fee is less than 100% of the aggregate transaction fees and the revenue share fee is the balance of the aggregate transaction fees. The revenue share transaction may be a record in the EFT file 1302 or a separate transaction. Referring to FIG. 16, generating the revenue share transaction comprises: i) at step 1602, calculating an originating bank revenue share amount, the originating bank revenue share amount being the aggregate transaction fee less the operator fee; ii) at step 1604, populating the pooling account identifier (or the operator account identifier) to a field of the revenue share transaction which identifies an account from which an revenue share amount is to be debited; iii) at step 1606, populating an account identifier of an account owned by the originating bank to a field of the revenue share transaction which identifies an account to which the revenue share amount is to be credited; and iv) at step 1608, populating the amount of the operator fee to a payment amount field of the operator fee transaction, the amount of the operator fee being a portion of the aggregate transaction fee

Step 200 represents debiting the revenue share amount from the pooling account (or operator account 37) and step 202 represents crediting the revenue share amount to the originating bank's account.

Steps 204 through 206 represent providing remittance information to each vendor which receives payment. Step 204 represents a vendor, using a vendor system 61a, 61b, 61c as depicted in FIG. 3, connecting to the system 10 which may be by way of secure connection over the network 20. Step 205 represents looking up the remittance records 514 from the remittance database 512 which represent payments to the connecting vendor and populating those records to a remittance object. Step 206 represents rending the remittance object on the vendor system 61a, 61, 61c.

In summary, the present invention provides a system for making payments from a payer to a community of vendors, assessing a variable transaction fee to each vendor, and providing revenue share to each of a group of participating banks.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A payment system for making payments from each payer of a community of payers to each vendor of a community of vendors, the community of payers comprising multiple distinct sub groups of payers, each sub group being uniquely associated with a distinct bank of a group of participating banks, the payment system comprising:
a computer readable medium;
a processor coupled to the computer readable medium;
a payer database encoded to the computer readable medium, the payer database comprising a unique payer record for each payer of the community of payers, each payer record comprising: i) identification of a distinct one of the payers; and ii) a unique system ID assigned to the payer;
a vendor database encoded to the computer readable medium, the vendor database comprising a unique vendor record for each vendor of the community of vendors, each vendor record comprising: i) identification of a distinct one of the vendors; ii) a unique system ID assigned to the vendor; and iii) a vendor remittance account identifier, the vendor remittance account identifier comprising a routing number and account number of a bank account to which payments to the vendor are transferred;
a participating bank database encoded to the computer readable medium, the participating bank database comprising a unique bank record for each participating bank of the group of participating banks, each bank record comprising: i) identification a distinct one of the banks; and ii) a pooling account identifier, the pooling account identifier comprising a routing number and account number of an account of the bank from which all payments initiated by the sub-group of payers associated with the bank are paid;
a group of unique payment instruction files coded to the computer readable medium, each payment instruction file being generated by a distinct originating bank, the originating bank being a bank within the group of participating banks, each payment instruction file comprising:
identification of the originating bank;
a group of unique payment records, each payment record comprising: i) the system ID of a disbursing payer, the disbursing payer being a payer within the sub group of payers associated with the originating bank; ii) the system ID of a selected vendor, the selected vendor being a vendor within the community of vendors to which the disbursing payer is issuing a payment; and iii) identification of the amount of the payment;
a payment application comprising instructions coded to the computer readable medium and executed by the processor, the instructions comprising:
in response to receipt of each payment instruction file, generating an electronic funds transfer file with a group of fund transfer records by, for each payment record of the payment instruction file:
assigning a unique payment ID to the payment record of the payment instruction file and populating the payment ID to a unique one of the fund transfer records;
populating the amount of the payment from the payment record of the payment instruction file to the fund transfer record;
looking up in the participating bank database, the pooling account identifier of the originating bank and populating the pooling account identifier of the originating bank to a field of the fund transfer record identifying an account from which the payment is debited; and
looking up, in the vendor database, the vendor account identifier for so the selected vendor and populating such vendor account identifier to a field of the fund transfer record identifying an account to which the payment is credited;
looking up the originating bank providing the payment instruction file from which the electronic fund transfer file is generated; and
transferring the electronic fund transfer file to the originating bank for execution.

2. The system of claim 1:
each payment record of each payment instruction file further comprises remittance information, the remittance information being text describing the purposes of the payment;
the system further comprises a remittance database encoded to the computer readable medium, the remittance database comprising a group of remittance records, each remittance record comprising, for a unique payment: i) the payment ID; ii) the system ID of the disbursing payer; iii) the system ID of the selected vendor; iv) the payment amount; and v) the remittance information;
the instructions of the payment application further include, for each fund transfer record generated, populating to a record of the remittance database: i) the payment ID; ii) the system ID of the disbursing payer; iii) the system ID of the selected vendor; iv) the payment amount; and v) the remittance information; and
the system further comprises remittance instructions encoded to the computer readable medium and executed by the processor, the remittance instructions comprising:
in response to a connecting vendor establishing a secure session with the system, generating a remittance object by looking up those remittance records of the remittance database which includes the system ID of the connecting vendor and populating those remittance records to the remittance object; and
rendering the remittance object on a remote system of the connecting vendor.

3. The system of claim 1, wherein:
each payer record of the payer database further includes a payer transaction account identifier, the payer transaction account identifier comprising a routing number and account number of a bank account from which funding is obtained for payments issued by the payer; and
the instructions of the payment application further include:
in response to receipt of each payment instruction file calculating, for each disbursing payer, a funding total, the funding total being the sum of the amounts of all payments represented by payment records in the payment instruction file which are being made by the disbursing payer;
generating funding transaction for each disbursing payer by:
looking up, in the payer database, the payer transaction account identifier for the disbursing payer and populating such payer transaction account identifier to a field of the funding transaction which identifies an account from which to debit the funding total;
looking up, in the participating bank database, the pooling account identifier of the originating bank;
populating the pooling account identifier to a field of the funding transaction with identifies an account to which the funding total is credited; and
providing the funding transaction to the originating bank for execution.

4. The system of claim 3:
further comprising a funding approval instructions encoded to the computer readable medium and executed by the processor, the funding approval instructions comprise, in response to each disbursing payer establishing a secure session with the system:
generating a funding approval object by looking up the funding total calculated for the disbursing payer;
rendering the funding approval object with the funding total on a remote system of the disbursing payer; and
obtaining disbursing payer approval of the funding total from the remote system on which the funding approval object is rendered; and
the instructions of the payment application only provide the funding transaction to the originating bank after disburser payer approval of the funding total is obtained.

5. The system of claim 1, wherein:
the payment amount in each record of the payment instruction file is a gross payment amount;
the payment amount in each record of the electronic funds transfer file is a net payment amount, the net payment amount being the gross payment amount reduced by a vendor transaction fee;
the instructions of the payment application further include:
calculating an aggregate transaction fee, the aggregate transaction fee being the sum of each vendor transaction fee for each record of the electronic funds transfer file;
generating an operator fee transaction by:
populating the pooling account identifier to a field of the operator fee transaction which identifies an account from which an operator fee is to be debited,
populating an operator account identifier to a field of the operator fee transaction which identifies an account held by the operator of the system and to which the operator fee is to be credited;
populating the amount of the operator fee to a payment amount field of the operator fee transaction, the amount of the operator fee being a portion of the aggregate transaction fee; and
providing the operator fee transaction to the originating bank for execution.

6. The system of claim 5, wherein:
the operator fee is less than one hundred percent of the aggregate transaction fee; and
the instructions of the payment application further include:
calculating an originating bank revenue share amount, the originating bank revenue share amount being the aggregate transaction fee less the operator fee;
generating a revenue share transaction by:
populating the pooling account identifier to a field of the revenue share transaction which identifies an account from which an revenue share amount is to be debited,
populating an account identifier of an account owned by the originating bank to a field of the revenue share transaction which identifies an account to which the revenue share amount is to be credited;
populating the revenue share amount to a payment amount field of the revenue share transaction, the revenue share amount being a portion of the aggregate transaction fee; and
providing the revenue transaction to the originating bank for execution.

7. The system of claim 5, wherein:
each vendor record of the vendor database further includes a unique group of payer rate records, each payer rate record includes, for a payer of the community of payers which makes payment to the vendor, the system ID assigned to the payer and a transaction fee rate applied to payments from the payer to the vendor:
the transaction fee rate of at least one payer rate record associated with one of the vendor records being different than the transaction fee rate of at lease a second payer rate record associated with the same vendor record; and
the transaction fee rate for at least one payer rate record associated with a first vendor record that includes a system ID assigned to a first payer is different than the transact fee rate of at least one payer rate record associated with a different vendor record that also includes a payer rate record with the same system ID assigned to the first payer; and
the instructions of the payment application further include, for each record of the electronic funds transfer file:
looking up, in the vendor database, in the vendor record with the system ID of the selected vendor, the transaction fee rate in the payer rate record with the system ID of the disbursing payer;
calculating the vendor transaction fee, the vendor transaction fee being the product of the transaction fee rate multiplied by the gross payment amount.

8. A payment system for making payments from each payer of a community of payers to each vendor of a community of vendors, the community of payers comprising a multiple distinct sub groups of payers, each sub group being uniquely associated with a distinct bank of a group of participating banks, the payment system comprising:
a computer readable medium;
a processor coupled to the computer readable medium;
a payer database encoded to the computer readable medium, the payer database comprising a unique payer record for each payer of the community of payers, each payer record comprising: i) identification of a distinct one of the payers; and ii) a unique system ID assigned to the payer;
a vendor database encoded to the computer readable medium, the vendor database comprising a unique vendor record for each vendor of the community of vendors, each vendor record comprising: i) identification of a distinct one of the vendors; ii) a unique system ID assigned to the vendor; and iii) a vendor remittance account identifier, the vendor remittance account identifier comprising a routing number and account number of a bank account to which payments to the vendor are transferred;
a participating bank database encoded to computer readable medium, the participating bank database comprising a unique bank record for each participating bank of the group of participating banks, each bank record comprising: i) identification a distinct one of the banks; and ii) a pooling account identifier, the pooling account identifier comprising a routing number and account number of an account of the bank from which all payments initiated by the sub-group of payers associated with the bank are paid;
a group of unique payment instruction files, each encoded to the computer readable medium, each payment instruction file being generated by a disbursing payer, the disbursing payer being a distinct payer or the group of payers, the payer being associated with an originating bank, the originating bank being the bank associated with the subgroup of payers to which the disbursing payer is a member, each payment instruction file comprising:
a group of unique payment records, each payment record comprising: i) the system ID of a selected vendor, the selected vendor being a vendor within the community of vendors to which the disbursing payer is issuing a payment; and ii) identification of the amount of the payment;
a payment application comprising instructions encoded to the computer readable medium and executed by the processor, the instructions comprising:
in response to receipt of each payment instruction file, generating an electronic funds transfer file with a group of fund transfer records by, for each payment record of the payment instruction file:
assigning a unique payment ID to payment record of the payment instruction file and populating the payment ID to a unique one of the fund transfer records;
populating the amount of the payment from the payment record of the payment instruction file to the fund transfer record;
looking up in the participating bank database, the pooling account identifier of the originating bank and populating the pooling account identifier of the originating bank to a field of the fund transfer record identifying an account from which the payment is debited;
looking up, in the vendor database, the vendor account identifier for the selected vendor and populating such vendor account identifier to a field of the fund so transfer record identifying an account to which the payment is credited; and
transferring the electronic fund transfer file to the originating bank for execution.

9. The system of claim 8:
each payment record of each payment instruction file further comprises remittance information, the remittance information being text describing the purposes of the payment;
the system further comprises a remittance database encoded to the computer readable medium, the remittance database comprising a group of remittance records, each remittance record comprising, for a unique payment: i) the payment ID; ii) the system ID of the disbursing payer; iii) the system ID of the selected vendor; iv) the payment amount; and v) the remittance information;
the instructions of the payment application further include, for each fund transfer record generated, populating to a record of the remittance database: i) the payment ID; ii) the system ID of the disbursing payer; iii) the system ID of the selected vendor; iv) the payment amount; and v) the remittance information; and
the system further comprises remittance instructions encoded to the computer readable medium and executed by the processor, the remittance instructions comprise:
in response to a connecting vendor establishing a secure session with the system, generating a remittance object by looking up those remittance records of the remittance database which includes the system ID of the connecting vendor and populating those remittance records to the remittance object; and
rendering the remittance object on a remote system of the connecting vendor.

10. The system of claim 8, wherein:
each payer record of the payer database further includes a payer transaction account identifier, the payer transaction account identifier comprising a routing number and account number of a bank account from which funding is obtained for payments issued by the payer; and
the instructions of the payment application further include:
in response to receipt of each payment instruction file calculating, for the disbursing payer, a funding total, the funding total being the sum of the amounts of all payments represented by payment records in the payment instruction file received from the disbursing payer;
generating a funding transaction for the disbursing payer by:
looking up, in the payer database, the payer transaction account identifier for the disbursing payer and populating such payer transaction account identifier to a field of the funding transaction which identifies an account from which to debit the funding total;
looking up, in the participating bank database, the pooling account identifier of the originating bank;
populating the pooling account identifier to a field of the funding transaction with identifies an account to which the funding total is credited;
providing the funding transaction to the originating bank for execution.

11. The system of claim 10:
further comprising funding approval instructions encoded to the computer readable medium and executed by the processor, the funding approval instructions comprise:
in response to each disbursing payer establishing a secure session with the system, generating a funding approval object by looking up the funding total calculated for the disbursing payer;
rendering the funding approval object with the funding total on a remote system of the disbursing payer; and
obtaining disbursing payer approval of the funding total from the remote system on which the funding approval object is rendered; and
the instructions of the payment application only provide the funding transaction to the originating bank after disburser payer approval of the funding total is obtained.

12. The system of claim 8, wherein:
the payment amount in each record of the payment instruction file is a gross payment amount;
the payment amount in each record of the electronic funds transfer file is a net payment amount, the net payment amount being the gross payment amount reduced by a vendor transaction fee;
the instructions of the payment application further include:
calculating an aggregate transaction fee, the aggregate transaction fee being the sum of each vendor transaction fee for each record of the electronic funds transfer file;
generating an operator fee transaction by:
populating the pooling account identifier to a field of the operator fee transaction which identifies an account from which an operator fee is to be debited,
populating an operator account identifier to a field of the operator fee transaction which identifies an account held by the operator of the system and to which the operator fee is to be credited;
populating the amount of the operator fee to a payment amount field of the operator fee transaction, the amount of the operator fee being a portion of the aggregate transaction fee; and
providing the operator fee transaction to the originating bank for execution.

13. The system of claim 12, wherein:
the operator fee is less than one hundred percent of the aggregate transaction fee; and
the instructions of the payment application further include:
calculating an originating bank revenue share amount, the originating bank revenue share amount being the aggregate transaction fee less the operator fee;
generating a revenue share transaction by:
populating the pooling account identifier to a field of the revenue share transaction which identifies an account from which an revenue share amount is to be debited,
populating an account identifier of an account owned by the originating bank to a field of the revenue share transaction which identifies an account to which the revenue share amount is to be credited;
populating the revenue share amount to a payment amount field of the revenue share transaction, the revenue share amount being a portion of the aggregate transaction fee; and
providing the revenue share transaction to the originating bank for processing.

14. The system of claim 12, wherein:
each vendor record of the vendor database further includes a unique group of payer rate records, each payer rate record includes, for a payer of the community of payers which makes payment to the vendor, the system ID assigned to the payer and a transaction fee rate applied to payments from the payer to the vendor:
the transaction fee rate of at least one payer rate record associated with one of the vendor records being different than the transaction fee rate of at lease a second payer rate record associated with the same vendor record; and
the transaction fee rate for at least one payer rate record associated with a first vendor record that includes a system ID assigned to a first payer is different than the transact fee rate of at least one payer rate record associated with a different vendor record that also includes a payer rate record with the same system ID assigned to the first payer;
the instructions of the payment application further include, for each record of the is electronic funds transfer file:
looking up, in the vendor database, in the vendor record with the system ID of the selected vendor, the transaction fee rate in the payer rate record with the system ID of the disbursing payer;
calculating the vendor transaction fee, the vendor transaction fee being the product of the transaction fee rate multiplied by the gross payment amount.
